(19) United States
(12) Patent Application Publication
(10) Pub. No.: US 2013/0138574 A1
(43) Pub. Date: May 30, 2013

(54) PACKAGE AND FREIGHT SHIPPING SYSTEM AND METHOD, INCLUDING SHIPPING BY FULFILLMENT ENTITIES

(71) Applicant: Enroute Systems Corporation, Bellevue, WA (US)

(72) Inventors: Keith A. McCall, Sammamish, WA (US); Meagan R. Zeman, Seattle, WA (US)

(73) Assignee: Enroute Systems Corporation, Bellevue, WA (US)

(21) Appl. No.: 13/673,843

(22) Filed: Nov. 9, 2012

Related U.S. Application Data
(63) Continuation-in-part of application No. 13/418,053, filed on Mar. 12, 2012, now abandoned.
Application No. 13/418,053 is a continuation of application No. 12/885,254, filed on Sep. 17, 2010, now Pat. No. 8,150,781.
(60) Provisional application No. 61/558,596, filed on Nov. 11, 2011.
(60) Provisional application No. 61/243,924, filed on Sep. 18, 2009.

(51) Int. Cl. G06Q 10/08

(52) U.S. Cl. CPC G06Q 10/0834
USPC 705/334

(57) ABSTRACT

In various embodiments, methods, apparatus, systems, and computer-readable media associated with using historic and real-time analytic data to select fulfillment entities and/or shipping options for a provider to use to fulfill an order from a customer. In various embodiments, an order may be received by a provider and order information may be made available to one or more fulfillment entities. The fulfillment entities may provide offers to fulfill the shipment to the provider, which may select one or more of the fulfillment entities based on application of business rules based at least in part on the historic and real-time analytic data. Other embodiments may be disclosed and claimed.

### PRIORITY TO RELATED APPLICATIONS

This application claims the benefit of U.S. Provisional Application No. 61/558,596, entitled “Package Shipping System and Method, Including Store-to-Store Shipping,” filed Nov. 11, 2011. This application also claims the benefit of U.S. application Ser. No. 13/418,053, entitled “Package Shipping System and Method, Including Usage of Historical Analytic Data,” and filed Mar. 12, 2012, which is a continuation of U.S. application Ser. No. 12/885,254, entitled “Package Shipping System and Method, Including Usage of Historical Analytic Data,” filed Sep. 17, 2010, which itself claimed the benefit of U.S. Provisional Application No. 61/243,924, entitled “Method and Apparatus for Shipping Article,” filed Sep. 18, 2009. Each of the aforementioned applications is hereby incorporated by reference in its entirety.

### BACKGROUND

With the advance of the Internet and ecommerce, businesses and individuals increasingly utilize shippers to ship packages and freight they produce. Businesses and individuals may ship numerous packages and freight shipments each day, and may ship these to different destinations or under different constraints. For example, businesses and individuals may need to: ship packages overnight or by a specific time, ship to international destinations, ship via ground transportation (such as for dangerous materials), require signature at delivery, ship to difficult or untested destination addresses, consolidate packages for shipment on one pallet for freight shipment and other requirements.

Numerous shipping options exist for these businesses and/or individuals to utilize for shipping their packages and freight. Businesses and individuals may choose from numerous regionally- or nationally-based freight, package and letter carriers. Individual carriers offer varying rates of service based on destination, material, transportation requirements, and time requirements. With all of these competing options, it can be difficult for a business (more specifically, an employee of the business) or an individual to choose a shipping option which best or close to best support a particular or a group of shipping needs.

In existing systems, users are merely able to poll shippers to determine posted shipping costs for a package or freight shipment. Beyond that, these systems seldom provide users with additional useful information for the user to determine the “best” shipping option. A user, knowing only the cost of a particular shipping option, may be unsure about whether additional, unposted costs may present themselves during shipment. For example, if a package is not delivered on time, the shipper may be forced to refund money to the package's recipient. In another example, a particular destination may present challenges, such as tacked-on shipper fees for recipients who are frequently not at home or difficult to find. These costs may not be adequately repressed in a shipper's posted fees to aid the user in carefully choosing the shipper for their packages.

Further, in existing systems, a business may receive orders for items from customers that may be shipped (or otherwise fulfilled) in various ways. For example, a business may be associated with stores that may have inventory that could fulfill an order. However, different stores may have different items in stock. Additionally, different stores may have different access to shipping options, such as due to the stores' geographical locations, hours, or other qualities. Thus, while these stores may wish to fulfill customer orders, they may have difficulty in deciding whether to do so in an efficient manner.

### BRIEF DESCRIPTION OF THE DRAWINGS

FIG. 1 illustrates a block diagram of selected components of a package shipment facilitation system using historic and real-time analytical data,

FIG. 2 illustrates a process for shipping a package using historic and real-time analytical data,

FIG. 3 illustrates a process for receiving historic and real-time analytical shipping data,

FIG. 4 illustrates an example of a display showing historic and real-time analytical shipping data,

FIG. 5 illustrates a process for receiving a business rule to use when choosing a shipping option,

FIG. 6 illustrates an example of an interface for receiving a business rule,

FIG. 7 illustrates an example of a display showing multiple shipping business rules,

FIG. 8 illustrates a process for generating a business rule,

FIG. 9 illustrates a process for applying business rules to package parameters to identify preferred shipping options,

FIG. 10 illustrates an example computing device configured to practice various aspects of the earlier described methods,

FIG. 11 illustrates an example block diagram of a shipping system network including a provider of items and one or more fulfillment entities,

FIG. 12 illustrates a process for fulfilling orders placed with a provider by one or more fulfillment entities,

FIG. 13 illustrates a process for selecting a fulfillment entity to fulfill an order, and

FIGS. 14-17 illustrate example interfaces for item fulfillment techniques described herein, all arranged in accordance with various embodiments of the present disclosure.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of different configurations, all of which are explicitly contemplated herein.

The herein described subject matter sometimes illustrates different components or elements contained within, or connected with, different other components or elements. It is to be understood that such depicted architectures are merely examples, and that in fact many other architectures may be implemented which achieve the same functionality. In a conceptual sense, any arrangement of components to achieve the same functionality is effectively “associated” such that the desired functionality is achieved. Hence, any two components herein combined to achieve a particular functionality may be seen as “associated with” each other such that the desired functionality is achieved, irrespective of architectures or intermedial components. Likewise, any two components so associated may also be viewed as being “operably connected”, or “operably coupled”, to each other to achieve the desired functionality, and any two components capable of being so associated may also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Various aspects of the subject matter described herein are described using terms commonly employed by those skilled in the art to convey the substance of their work to others skilled in the art. However, it should be apparent to those skilled in the art that alternate implementations may be practiced with only some of the described aspects. For purposes of explanation, specific numbers, materials, and configurations are set forth in order to provide a thorough understanding of the illustrative examples. However, it should be apparent to one skilled in the art that alternate embodiments may be practiced without the specific details. In other instances, well-known features are omitted or simplified in order not to obscure the illustrative embodiments.

With respect to the use of substantially any plural and/or singular terms herein, those having skill in the art may translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and e, etc.” is used, in general such a construction is intended in the sense one having skill in the art would understand the convention (e.g., “a system having at least one of A, B, and C” would include but not be limited to systems that have A alone, B alone, C alone, A and B together, A and e together, Band e together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, Band C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

Various operations may be described as multiple discrete operations in turn, in a manner that may be helpful in understanding embodiments; however, the order of description should not be construed to imply that these operations are order dependent. Also, embodiments may have fewer operations than described. A description of multiple discrete operations should not be construed to imply that all operations are necessary. Also, embodiments may have fewer operations than described. A description of multiple discrete operations should not be construed to imply that all operations are necessary.

The disclosure is drawn, inter alia, to techniques, methods, apparatuses, systems, articles of manufacture, and computer-readable media related to facilitating shipping of packages using historic analytical shipping data.

Described embodiments include techniques, methods, apparatuses, systems, articles of manufacture, and non-transitory tangible computer-readable media which may be associated with using shipping business rules which may identify shipping options for a business or other user to use when shipping a package. In various embodiments, historic and real-time analytic data (or “analytics”) may be received and maintained by a package shipment facilitation system. In some embodiments, these analytics may be received for the particular location of a business, or for selected or all locations of a business; in some embodiments, the analytics may be received for multiple businesses. The analytics may then be used, in various embodiments, to generate business rules for a location of a business or for selected or all locations of a business. These business rules may be applied to parameters for a package that is to be shipped. Through application of the business rules, one or more preferred shipping options may be identified. In various embodiments, business rules may be received after being manually-generated by a user. In various embodiments, the business rules may be received and/or generated based at least in part on the stored historic analytics. After a shipping option is chosen for the package, a shipping label may be printed for the package, and the package may be entered into a shipper's system for processing.

Through the use of historic analytics, potential savings can be identified. In various embodiments, these savings may include improved efficiency, reduced costs, and enhanced quality and security of package and freight delivery. Through the use of these analytics and identification of shipping options, benefits to the business may be obtained other than those directly represented by a shipper's posted cost.

In various embodiments, a provider of items may receive an order, such as from a customer, and then have that order fulfilled by one or more fulfillment entities, such as, for example, stores. A store is simply one example of a fulfillment entity, however. In various embodiments, fulfillment entities may include owned or managed warehouses, third party logistics providers, or vendors, suppliers and drop shippers that send shipments on behalf of the business. The order may be received, for example, by a website or other interface to the provider. The provider may then select a fulfillment entity to fulfill and ship the order. In various embodiments, the fulfillment entity may be selected using business rules. The business rules may be used to select the store based on the fulfillment entity having the item in stock as well as based on available shipping options, such as the fulfillment entity's geography or shippers or shipping options available to the fulfillment entity. In various embodiments, the provider may select a fulfillment entity based in part on a bids received from the fulfillment entity. In various embodiments, an intermediate fulfillment entity that has an item but does not ship directly to a customer may ship to another fulfillment entity that can perform the direct ship. In various embodiments, the provider may also chose different rules for shipping based on the particular contents being shipped, such as by using knowledge of what has been placed in a particular box or other container.

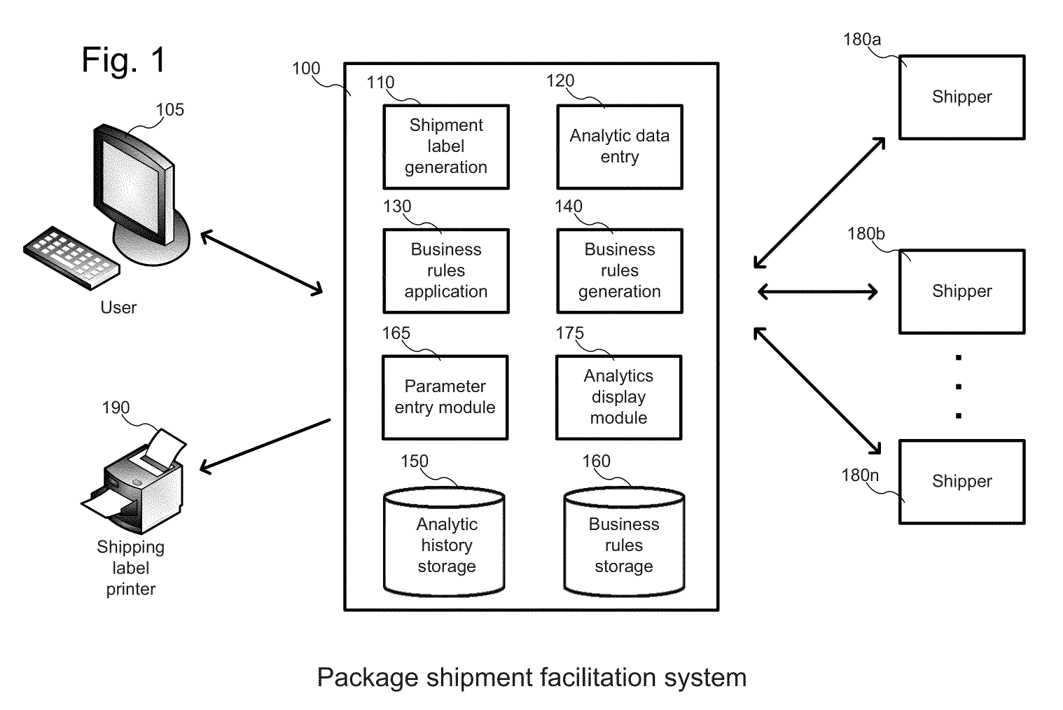

FIG. 1 illustrates a block diagram of selected components of a package shipment facilitation system 100 according to various embodiments. In the illustrated example, the package shipment facilitation system 100 may communicate with a user 105 (typically of a business) to facilitate the user in shipping packages (for the business). In various embodiments, the illustrated user 105 may be a user at a business, an individual acting on their own behalf, or may represent multiple users which act on behalf of a business. In various embodiments, the user 105 may interact with the package shipment facilitation system 100 though a computer-based interface. For example, in one embodiment, the user may interact with the package shipment facilitation system 100 through a dedicated application which communicates with the package shipment facilitation system 100, such as an application executing on the user's computer. In another embodiment, the user may interact with the package shipment facilitation system 100 through a web-based interface, such as through a web page or through a toolbar installed on a web-browser. In other embodiments, other users may also interact with the package shipment facilitation system 100 in various embodiments, either at the same business or at other sites. These users are not illustrated in FIG. 1 for the sake of clear illustration.

In various embodiments, the package shipment facilitation system 100 may also interact with one or more shippers, illustrated in FIG. 1 as shippers 180a-180n. In various embodiments, these shippers 180a-180n may comprise local, regional, and/or nationally-based shipping companies. In various embodiments, the package shipment facilitation system 100 may interact with the shippers 180a-180n through known techniques, such as through application programming interfaces provided by one or more of the shippers 180a-180n. In other embodiments, the package shipment facilitation system 100 may communicate with the shippers 180a-180n through web or other telecommunications interfaces. In various embodiments, the package shipment facilitation system 100 communicates with the shippers 180a-180n to acquire information about shipping options, including transportation options offered by shippers (e.g., ground or air), time frames for shipments, insurance options, etc. In various embodiments, tracking and/or cost information may also be obtained by the package shipment facilitation system 100 from the shippers 180a-180n. In this way, historical shipping analytic data may be obtained from the shippers 180a-180n in order to facilitate package shipping, as described herein. In other embodiments, the package shipment facilitation system 100 may communicate with the shippers 180a-180n to send package information and begin shipments.

In various embodiments, the package shipment facilitation system 100 may comprise one or more modules, such as software, hardware, and/or firmware modules to perform various shipping facilitation operations for the package shipment facilitation system 100. In various embodiments, the modules may interact with the user 105 and/or with shippers 180a-180n.

For example, in various embodiments, the package shipment facilitation system 100 may comprise an analytic data entry module 120. In various embodiments, the analytic data entry module 120 may provide for one or more users to input historic and real-time analytic data about past shipments. In another embodiment, the analytic data entry module 120 may be configured to request and receive historic and real-time analytic data from the shippers 180a-180n. In various embodiments the analytic data entry module, after receiving the historic and real-time analytic data, may store the historic and real-time analytic data in the analytic history storage 150. In various embodiments, the analytic history storage 150 may comprise various storage devices and/or software storage modules, including, for example, a database and one or more hard drive and/or solid-state storage devices. In various embodiments, the historic and real-time analytic data may be displayed to a user using the illustrated analytics display module 175.

In various embodiments, the package shipment facilitation system 100 also comprises a business rules storage 160, which stores one or more business rules. In various embodiments, the business rules stored in the business rules storage 160 may be applied to parameters for a package to be shipped in order to identify one or more preferred shipping options which may be used for that package. The business rules application module 130 may be used, in various embodiments, to perform application of one or more of the business rules to the parameters to identify the one or more preferred shipping options. Various embodiments of the parameters for a package may include, for example, destination, time frame, and/or transportation type. In various embodiments, the parameters for a package may be entered by the user through an interface facilitated by the illustrated parameter entry module 165.

As will be described below, in various embodiments, the business rules may be received directly from the user, such as by the user creating one or more business rules manually using the business rules generation module 140. In other embodiments, the business rules generation module 140 may automatically generate one or more business rules, as will be described herein. In various embodiments, the business rules generation module 140 may also allow the user to prioritize and/or edit previously-entered business rules.

After identification of one or more preferred shipping options, the package shipment facilitation system 100 may, through its shipment label generation module 110, generate one or more shipping labels for a package. This shipping label may, in some embodiments, be printed on a shipping label printer 190, such as a printer attached to a computer of the user 105.

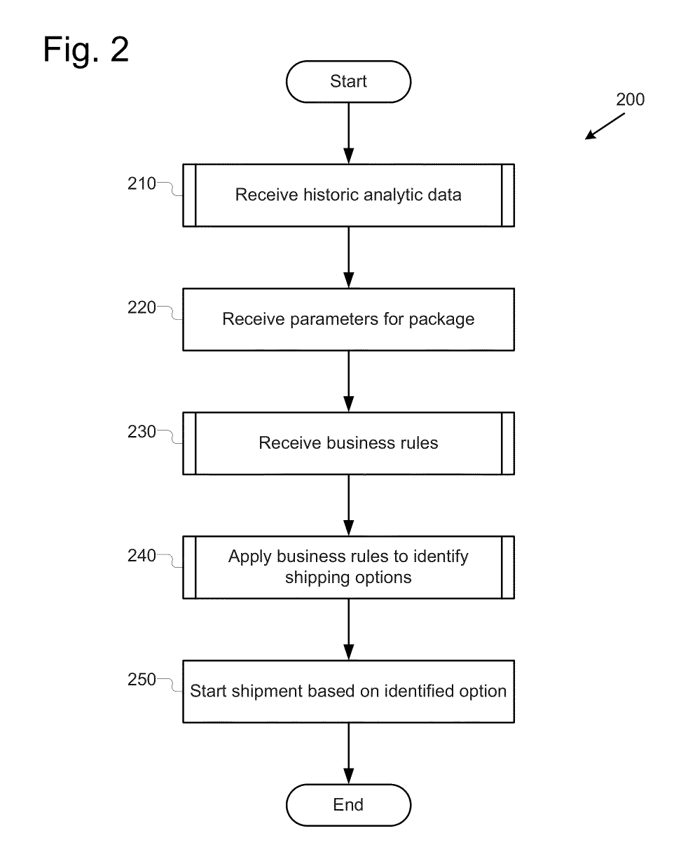

FIG. 2 illustrates an example process 200 for the package shipment facilitation system 100 to facilitate shipping a package using historic analytical data. In various embodiments, the operations illustrated in process 200 may be combined, split into multiple separate operations, or omitted entirely. The process may begin at operation 210, where the package shipment facilitation system 100 may receive historic and real-time analytic data regarding past shipments which have been made by the user or by other users and/or businesses. In one embodiment, operation 210 is performed by analytic data entry module 120. Particular details of operation 210 are described below. Next, at operation 220, the package shipment facilitation system 100 may receive parameters for a package. As discussed herein, in various embodiments, the parameters may include data such as, but not limited to, destination, time frame for shipment, insurance, whether the package should be signed for upon receipt, insurance, preferred cost, etc.

At operation 230, the package shipment facilitation system 100 may receive business rules. In various embodiments, these business rules may be particular to the user (or a location of a business) shipping the package, and/or may be generated or received based on other users (and/or other locations of the business and/or other businesses). In various embodiments operation 230 may be performed in whole or in part, by the business rules generation module 140. In various embodiments, business rules may be received prior to receiving either analytic data or parameters for a particular package. Particular details of operation 230 are described below.

At operation 240, the package shipment facilitation system 100 may apply the received business rules to the parameters received at operation 220 to identify one or more preferred shipping options. In various embodiments, the application may be performed through operation of the business rules application module 130. Particular details of operation 240 are described below. At operation 250, the package shipment facilitation system 100 may start a shipment of the package based on one of the identified shipping options. In various embodiments, the package shipment facilitation system 100 may print out a shipping label for the user, send package information to a shipper, and/or begin financial transactions to start the shipment. The process may then end.

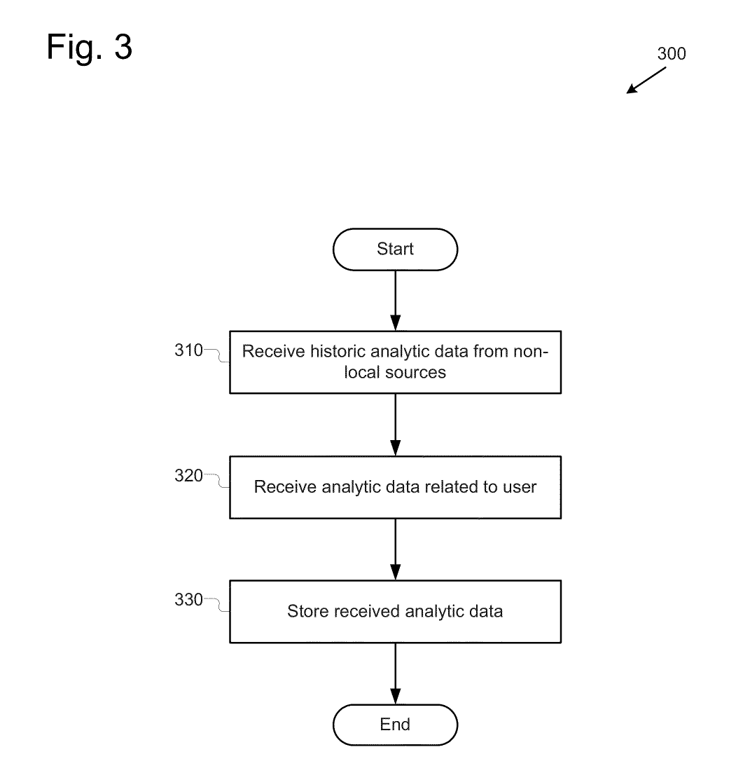

FIG. 3 illustrates an example process 300 for the analytic data entry module 120 of the package shipment facilitation system 100 to receive historic and real-time analytic data. In some embodiments, process 300 may be performed in one or more implementations of operation 210 of FIG. 2. In various embodiments, the operations illustrated in process 300 may be combined, split into multiple separate operations, or omitted entirely. The process may begin at operation 310, where the analytic data entry module 120 may receive historic and real-time analytic data from non-local sources. In one embodiment, the analytic data entry module 120 may receive historic and real-time analytic data from shippers, such as shippers 180a-180n. In another embodiment, the analytic data entry module 120 may receive historic and real-time analytic data from multiple users, such as users representing various businesses. By aggregating this historic data, business rules may be created which are more robust and which offer better efficiencies to users than if the business rules were created entirely from locally-obtained analytic data. At operation 320, the analytic data entry module 120 may receive analytic data related to the user (or the user's business). In one embodiment, this may comprise receiving manually-entered data about past shipments the user or business has made. In another embodiment, the user may obtain shipping records, such as from shippers 180a-180n, and input these into the analytic data entry module 120. In other embodiments, historic and real-time analytic data related to the user or the user's business may be entered into the analytic data entry module 120 via other methods. At operation 330, the analytic data entry module 120 may store the received historic and real-time analytic data, such as by generating or updating a database in the analytic history storage 150. The process may then end.

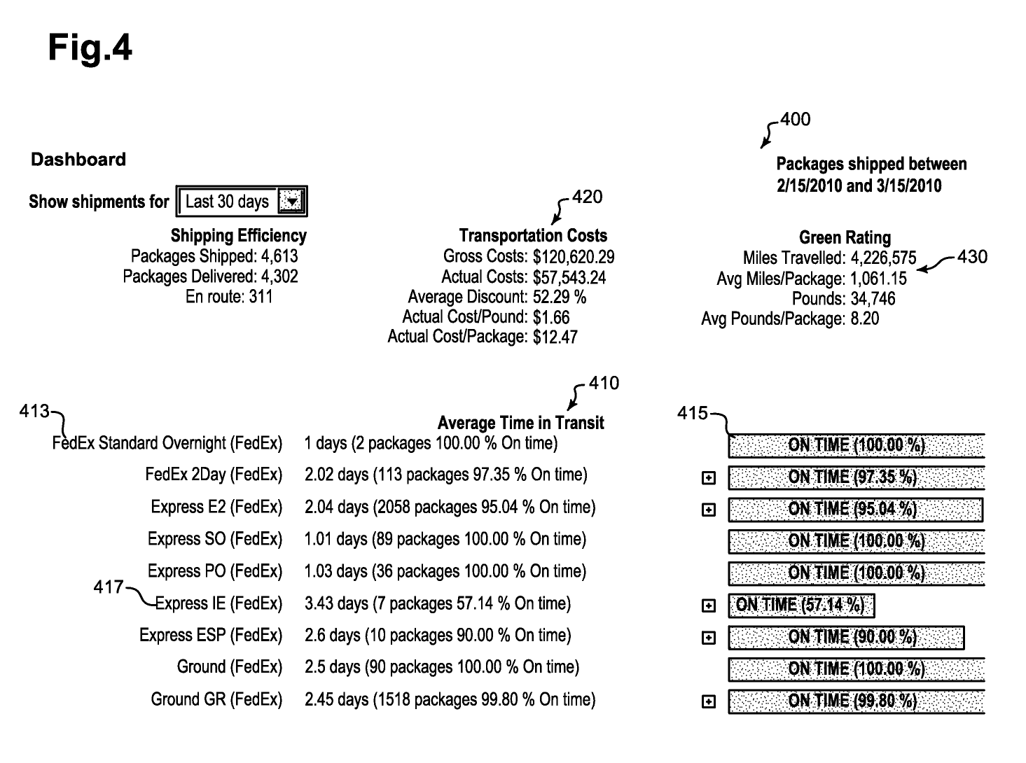

FIG. 4 illustrates an example of a display 400 showing historic analytical shipping data. The display may be presented to a user for review to generate business rules, or simply to review historical trends. In various embodiments, the display is generated by the analytics display module 175, such as by generating a web page or by sending information to software operating on the computer of the user 105. In the embodiment illustrated, historic analytics are based on a particular user's personal shipping history for a time period between Feb. 15, 2010 and Mar. 15, 2010. In the example, historic and real-time analytic data about shipping times is displayed under listing 410, titled “Average time in transit.” Example analytic 413 shows that, for this measured time period, FedEx Standard Overnight has had an average transit time of 1 day for two packages. Furthermore, this represents a 100% on-time rate compared to expected transit times. The display also shows a graphical representation of the on-time rate at example 415. By contrast, example analytic 417 shows that for this user using the Express IE shipping option during the measured time period, the user experienced, a 3.43 day average transit time for 7 packages. The example also shows that only 57.14% of these packages were on time. In other examples, aggregate analytics may be displayed for a user by the analytics display module 175, such as the aggregate transportation costs information 420 or the aggregate green ratings 430. In various embodiments, historic and real-time analytic data such as those displayed, including cost, time, and green-rating data, may be used to generate business rules, as described below.

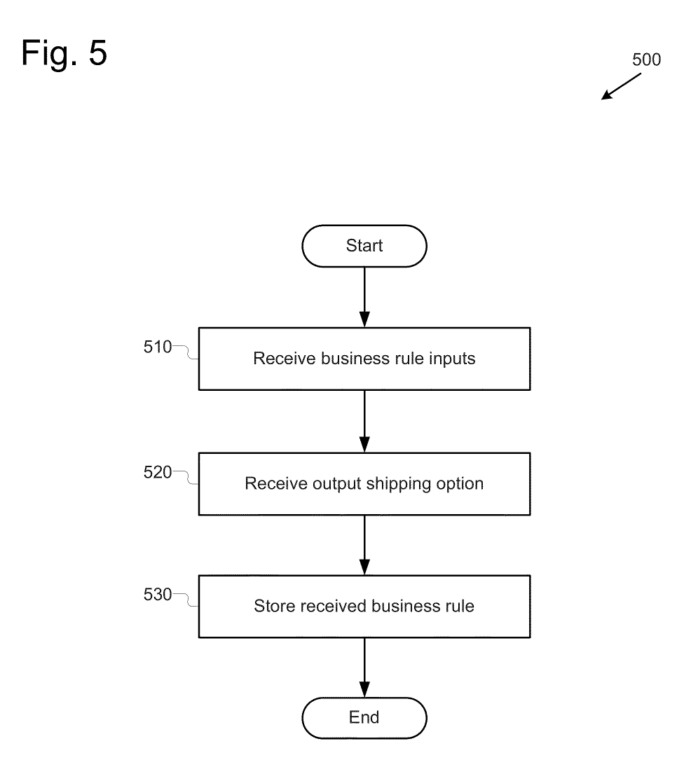

FIG. 5 illustrates an example process 500 for the business rules generation module 140 of the package shipment facilitation system 100 to receive a business rule. Process 500 may be performed in one or more implementations of operation 230 of FIG. 2 to receive manually-created business rules from a user. The process may begin at operation 510, where the business rules generation module 140 may receive business rule inputs. In various embodiments, business rule inputs may comprise, for example, destination information, package information, time frame requirements, and/or other package information. At operation 520, the business rules generation module 140 may receive an output shipping option which is to be applied to a package that satisfies the business rule inputs. In various embodiments, an indication for how many inputs are required for application of the business rule may be received. For example, in various embodiments, a received business rule may indicate that, if one of a set of business rule inputs is true, a particular output shipping option should be selected. In another embodiment, a received business rule may indicate that, only if every input out of a set of business rule inputs is true, then a particular output shipping option should be selected. At operation 530, the business rules generation module 140 may store the received business rule. In one embodiment, the business rules generation module 140 may store the received business rule by storing the rule in a business rules database in the business rules storage 160. The process may then end.

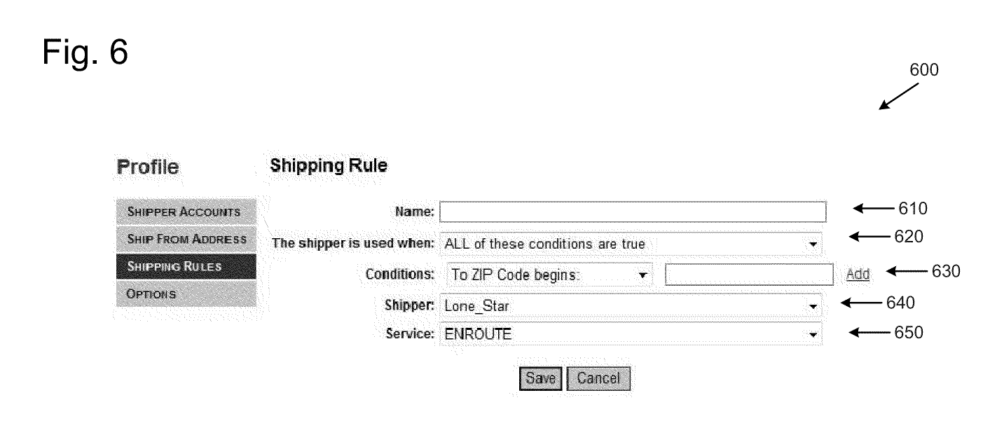

FIG. 6 illustrates an example of a display 600 showing one implementation of an interface for a user to manually enter business rules, such as by using the process of FIG. 5. In various embodiments, the interface in the display 600 may be provided to a user by the business rules generation module 140. At entry box 610, the user 105 may enter a name so that the business rule may be identified. At selection 620, the user may indicate whether the business rule should require that every or just one business rule input should be satisfied for the business rule to apply. Then, at entry 630, a business rule input may be input, illustrated in FIG. 6 as a “condition.” In the illustrated example, the user may enter a destination zip code as a business rule input. Additionally, the user 105 may click on an “Add” link to add additional business rule inputs. The example also shows a selection 640 for a shipper, which represents the output shipping option which is indicated when a proper number of business rule inputs are reached during rule application. Finally, the sample shows a selection 650 for a service to use with the carrier. Examples of services include next day, second day, ground, etc. In various embodiments, the services which are available for selection may depend on the carrier selection.

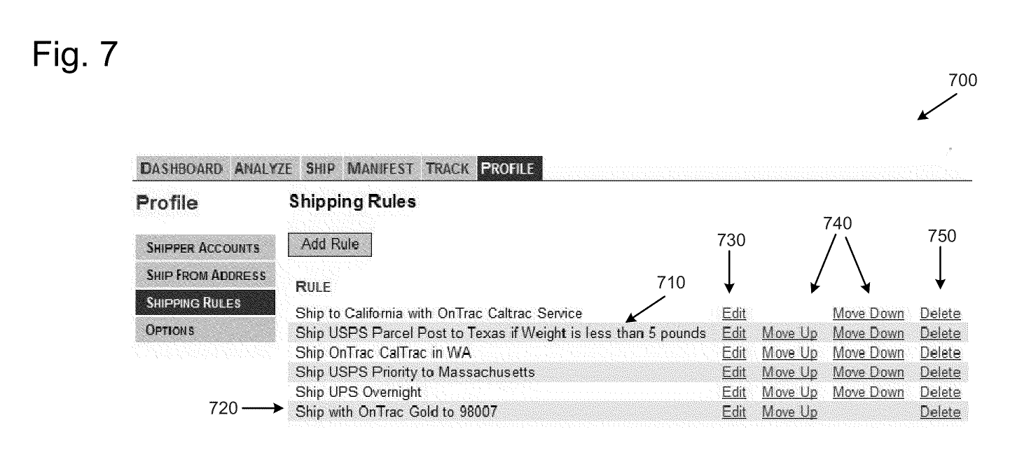

FIG. 7 illustrates an example of a display 700 showing one implementation of an interface for a user to review one or more business rules, as well as for editing and/or prioritizing the one or more business rules. In various embodiments, the interface in the display 700 may be provided to a user by the business rules generation module 140. As FIG. 7 illustrates, the display 700 may show more than one business rules, such as business rule example 710. In example 710, the exemplified business rule is applied to packages which: a) are to be sent to Texas, and b) weigh less than 5 pounds. In the business rule of example 710, when both of these inputs are satisfied, the business rule is applied to indicate that the package should be shipped via USPS Parcel Post. In the business rule of example 720, the rule indicates that OnTrac Gold is the preferred shipping option for packages which are to be sent to zip code 98007. The display also shows example action items 730, which allow a user to edit any of the previously-generated business rules, and example items 750, which allow the rules to be selectively deleted. Also, by selecting action items 740, the user 105 may move rules up or down in the list of business rules. In various embodiments, business rules may be ordered so that a user can establish precedence of one rule over another. Thus, in the example shown, the system will identify that a package sent to Washington should be shipped using OnTrac CalTrac even if that package is going to 98007. The system will indicate the use of OnTrac CalTrac over OnTrac Gold (which is the preferred shipper for 98007) because the former business rule is listed earlier in the list.

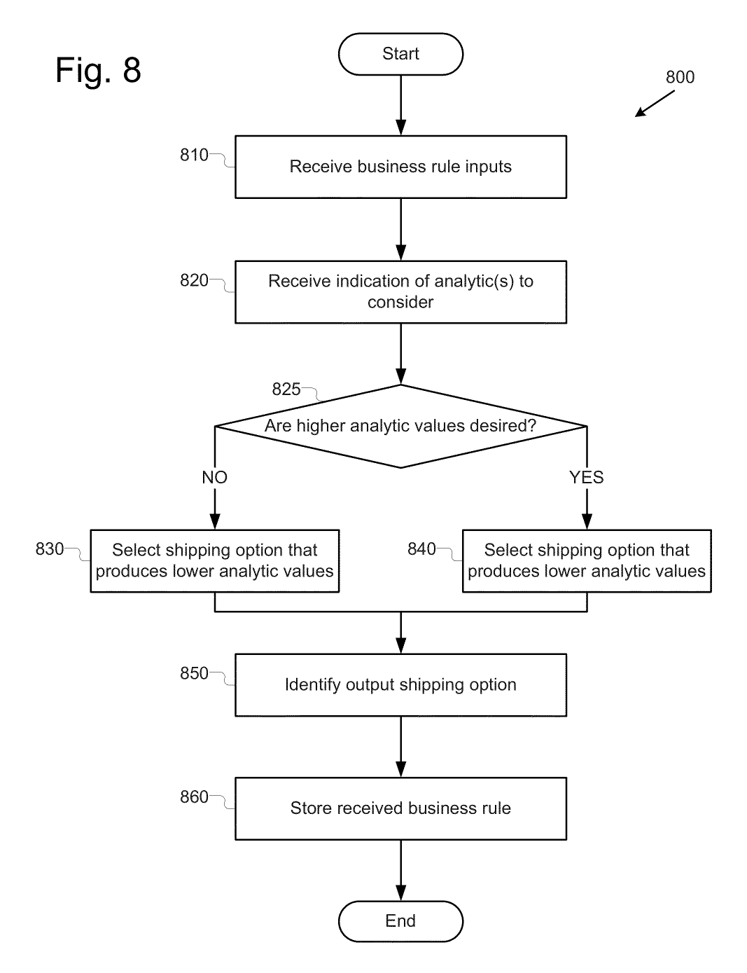

FIG. 8 illustrates an example process 800 for the business rules generation module 140 of the package shipment facilitation system 100 to automatically generate a business rule. In some embodiments, process 800 may be performed in one or more implementations of operation 230 of FIG. 2 to automatically generate business rules for a user or business, rather than relying on the user to manually create the rules. The process may begin at operation 810, where the business rules generation module 140 may receive business rule inputs. In various embodiments, business rule inputs may comprise, for example, destination information, package information, time frame requirements, and/or other package information. At operation 820, the business rules generation module 140 may receive one or more indications of one or more analytics to consider. In various embodiments the business rules generation module 140 seeks values for analytics which are more desired by a user.

In various embodiments, the analytics may be preferred by a user (or the user's business) to be higher or lower depending on the type of analytic being considered. Thus, in some embodiments, the business rules generation module 140 may operate to increase those analytics for which a higher value is desired by a user or business, such as on-time percentage. In other embodiments, the business rules generation module 140 may operate to decrease those analytics for which a lower value is desired by the user or business, such as cost or distance travelled. In various embodiments, at operation 820, the business rules generation module 140 may receive one or more indications of whether higher or lower values are desired for the one or more received analytics. In other embodiments, the business rules generation module 140 may be configured to recognize one or more of the analytics and to recognize, for those analytics, whether higher or lower values are desired.

At operation 825, the business rules generation module 140 determines, for an analytic, if a higher value is desired by a user or business. If not, then at operation 830 the business rules generation module 140 may seek out and set a shipping option for the business rule being generated which produces lower values for that analytic than other shipping options. If, however, a higher value is desired, at operation 840 the business rules generation module 140 may seek out and set a shipping option for the business rule being generated which produces higher values. In various embodiments, the business rules generation module 140 may seek out a shipping option by simulating shipping using one or more of the business rule inputs based on the historic analytical data stored in analytic history storage 150. In various embodiments, various shipping options may be simulated and compared to each other to perform the selection of operations 830 and 840. Then, at operation 850, the business rules generation module 140 identifies the output shipping option which, in simulation, produced the most desired analytic outcome. At operation 860, the business rules generation module 140 may store the generated business rule. In one embodiment, the business rules generation module 140 may store the generated business rule by storing the rule in a business rules database in the business rules storage 160. The process may then end.

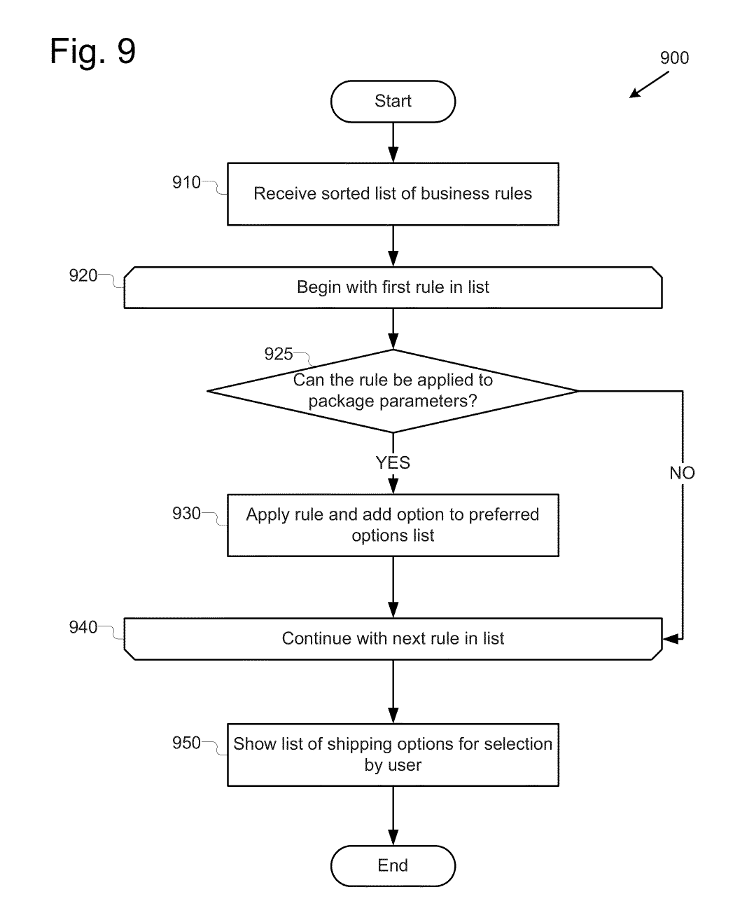

FIG. 9 illustrates an example process 900 for the business rules application module 130 of the package shipment facilitation system 100 to apply generated business rules for a package. In some embodiments, process 900 may be performed in one or more implementations of operation 240 of FIG. 2. The process may begin at operation 910, where the business rules application module 130 module may receive a sorted list of business rules. In one embodiment, the business rules application module 130 may receive this list by querying the business rules storage 160. In some embodiments, the list may not be sorted. In some such embodiments, the user may be queried to resolve conflicts amongst rules.

At operation 920, a loop may be begun starting with the first rule in the list. At operation 925, the business rules application module 130 may determine if the currently-considered rule can be applied to the parameters received for the package. In one embodiment, these parameters are received at operation 220 of FIG. 2. In various embodiments, the business rules application module 130 may determine if the rule can be applied by matching the business rule inputs identified in the rule to the parameters for the package being shipped. If the rule applies, then at operation 930, the rule may be applied and the output shipping options are added to a list of preferred options for the user. In one embodiment, not illustrated, once a rule is applied, the process may stop and the shipping option may be presented to the user. However, in alternative embodiments, such as the one illustrated, at operation 940, the loop may be continued for the next business rule in the sorted list. Then, at operation 950, the list created by successive applications of operation 930 may be shown to the user 105. The user may then select a shipping option and may start shipment of the package, such as at operation 250. The process of FIG. 9 may then end.

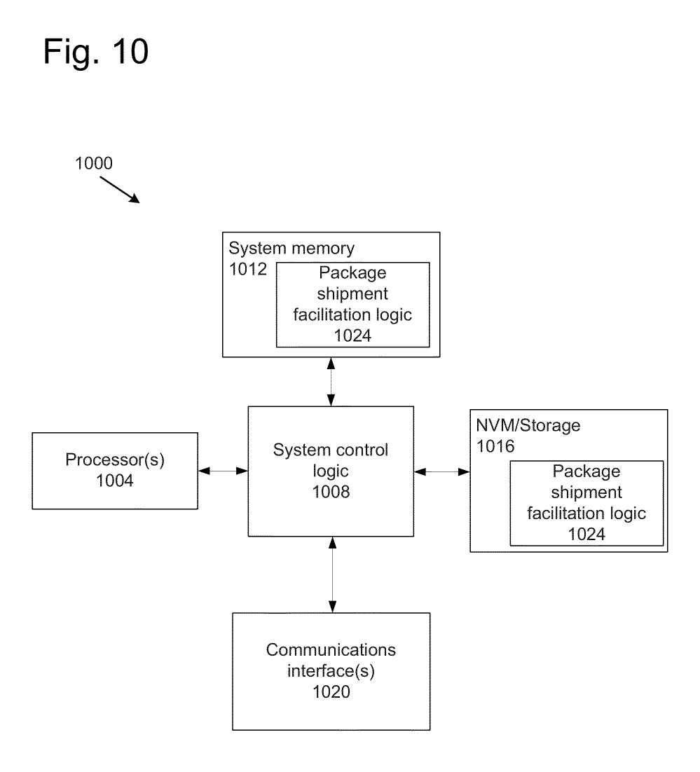

The techniques and apparatuses described herein may be implemented into a system using suitable hardware and/or software to configure as desired. FIG. 10 illustrates, for one embodiment, an example system 1000 comprising one or more processor(s) 1004, system control logic 1008 coupled to at least one of the processor(s) 1004, system memory 1012 coupled to system control logic 1008, non-volatile memory (NVM)/storage 1016 coupled to system control logic 1008, and one or more communications interface(s) 1020 coupled to system control logic 1008.

System control logic 1008 for one embodiment may include any suitable interface controllers to provide for any suitable interface to at least one of the processor(s) 1004 and/or to any suitable device or component in communication with system control logic 1008.

System control logic 1008 for one embodiment may include one or more memory controller(s) to provide an interface to system memory 1012. System memory 1012 may be used to load and store data and/or instructions, for example, for system 1000. System memory 1012 for one embodiment may include any suitable volatile memory, such as suitable dynamic random access memory (DRAM), for example.

System control logic 1008 for one embodiment may include one or more input/output (I/O) controller(s) to provide an interface to NVM/storage 1016 and communications interface(s) 1020.

NVM/storage 1016 may be used to store data and/or instructions, for example. NVM/storage 1016 may include any suitable non-volatile memory or non-transitory computer- readable media, such as flash memory, for example, and/or may include any suitable non-volatile storage device(s), such as one or more hard disk drive(s) (HDD(s)), one or more solid-state drive(s), one or more compact disc (CD) drive(s), and/or one or more digital versatile disc (DVD) drive(s) for example.

The NVM/storage 1016 may include a storage resource physically part of a device on which the system 1000 is installed or it may be accessible by, but not necessarily a part of, the device. For example, the NVM/storage 1016 may be accessed over a network via the communications interface(s) 1020.

System memory 1012 and NVM/storage 1016 may include, in particular, temporal and persistent copies of logic 1024. Logic 1024 may be configured to enable system 1000, in response to operation of the logic, to practice some or all aspects of the package shipment facilitation techniques described earlier. In various embodiments, logic 1024 may be implemented via programming instructions of any one of a number of programming languages, including but not limited to C, C++, C#, HTML, XML, and so forth.

Communications interface(s) 1020 may provide an interface for system 1000 to communicate over one or more network(s) and/or with any other suitable device. Communications interface(s) 1020 may include any suitable hardware and/or firmware. Communications interface(s) 1020 for one embodiment may include, for example, a network adapter, a wireless network adapter, a telephone modem, and/or a wireless modem. For wireless communications, communications interface(s) 1020 for one embodiment may use one or more antenna(s).

For one embodiment, at least one of the processor(s) 1004 may be packaged together with logic for one or more controller(s) of system control logic 1008. For one embodiment, at least one of the processor(s) 1004 may be packaged together with logic for one or more controllers of system control logic 1008 to form a System in Package (SiP). For one embodiment, at least one of the processor(s) 1004 may be integrated on the same die with logic for one or more controller(s) of system control logic 1008. For one embodiment, at least one of the processor(s) 1004 may be integrated on the same die with logic for one or more controller(s) of system control logic 808 to form a System on Chip (SoC).

In various embodiments, system 1000 may have more or fewer components, and/or different architectures.

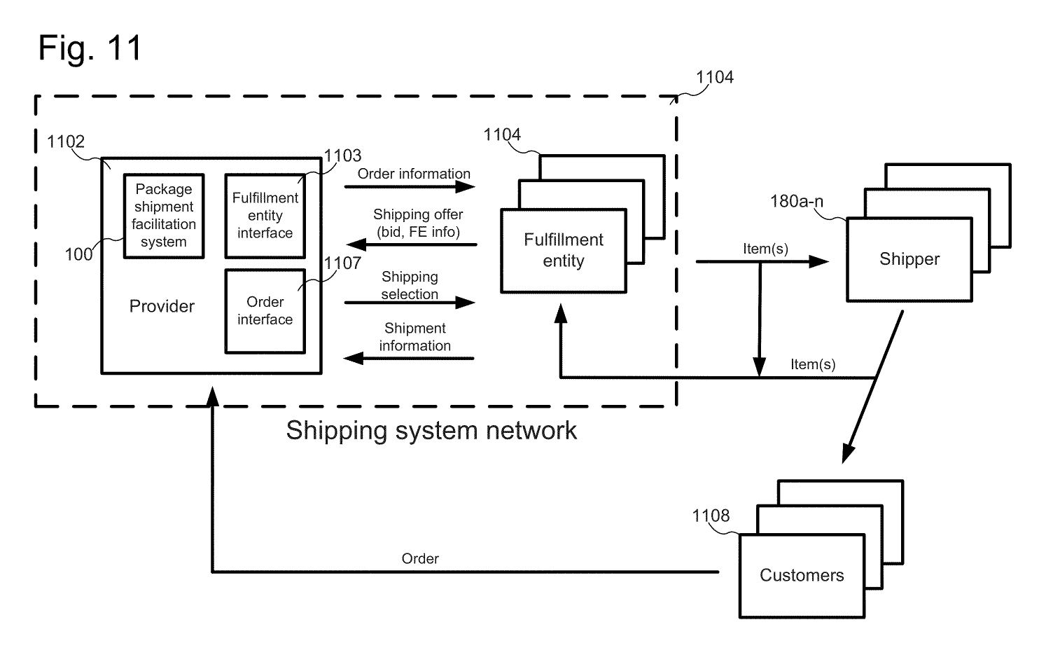

Referring now to FIG. 11, an example block diagram of a shipping system network 1100 including a provider of items and one or more fulfillment entities is illustrated in accordance with various embodiments. As illustrated, shipping system network 1100 may in various embodiments include a provider of items 1102, and one or more fulfillment entities 1104, coupled to each other, as well as to one or more shippers, such as shippers 180a-n. In embodiments, provider of items 1102, fulfillment entities 1104, and shippers 180a-n may be coupled with each other via one or more, wired and/or wireless, private and/or public, local and/or wide area networks.

In various embodiments, the provider 1102 may include a retail presence, such as an online retail interface and/or a physical retail environment. The provider 1102 may be equipped to receive orders for items from customers 1108. In various embodiments, the provider 1102 may receive orders through an order interface 1107. In various embodiments, the order interface 1107 may include a web-based, phone-based, or other electronic interface. In various embodiments, the provider 1102 may not itself have items that are ordered by the customers 1108, but instead may be equipped to select one or more fulfillment entities 1104 to fulfill and create shipments for the items. These shipments may be shipped by the fulfillment entities 1104 using the shippers 180a-n, such as described herein. In various embodiments, the provider 1102 may include one or more implementations of the package shipment facilitation system 100, such as those described herein. In various embodiments, the package shipment facilitation system 100 of the provider 1102 may be configured to select one or more of the fulfillment entities 1104 to ship one or more of the items, in addition to selecting one or more shipping options provided by the shippers 180a-n. As discussed above, fulfillment entities may, in various embodiments, include stores, owned or managed warehouses, third party logistics providers, or vendors, suppliers and drop shippers that send shipments on behalf of the business.

In various embodiments, the provider 1102 may be configured to communicate with one or more of the fulfillment entities 1104 in order to select fulfillment entities 1104 and/or shipping options for shipment of one or more items. In various embodiments, as described earlier, the provider 1102 and fulfillment entities 1104 may be coupled with each other, as well as with shippers 180a-n, such as via one or more private and/or public networks, e.g., the Internet. The coupling networks may be local or wide area, wired or wireless, or any combination there of In various embodiments, the fulfillment entities 1104 may include stores, warehouses, and/or other entities that may have items for order in stock and which can put together shipments. In various embodiments, one or more fulfillment entities 1104 may be configured to directly ship items to a customer. In various embodiments, one or more fulfillment entities 1104 may include intermediate fulfillment entities 1104 that may not be equipped to ship items to customers 1108, but which may be equipped to ship items to other fulfillment entities 1104 that are configured to ship directly to customers 1108. In various embodiments, shipping between fulfillment entities 1104 may be performed via one or more of the shippers 180a-n, and/or through other means. Thus, as FIG. 11 illustrates, items may be shipped from one or more fulfillment entities 1104 back to other fulfillment entities 1104. This shipping may be performed, in various embodiments, with or without one or more of the shippers 180a-n.

In various embodiments, once a customer has placed an order for an item with the provider 1102, the provider 1102 may broadcast information about that order to the fulfillment entities 1104. In various embodiments, the order may be provided to the fulfillment entities 1104 through a fulfillment entity interface 1103 of the provider 1102. In various embodiments, this information may be broadcast to the fulfillment entities 1104, such as, for example, through placement on an accessible database or bulletin board associated with the fulfillment entity interface 1103.

The fulfillment entities 1104 may, in various embodiments, respond to the broadcast of information by providing a shipping offer to fulfill all or part of the order. In various embodiments, the shipping offer may indicate that the fulfillment entities 1104 providing the shipping offer have one or more of the items in stock. In various embodiments, the shipping offer may include information to aid the package shipment facilitation system 100 of the provider 1102 to select one of the fulfillment entities 1104. This information may include a bid for fulfilling the order; the bid may include such information as price information, time-to-fulfillment, time-to-ship and/or other information. The fulfillment entity 1104 may also include non-bid information, such as the geographical location of the fulfillment entity, inventory information, shipping options and/or shippers available to the fulfillment entity, etc. In various embodiments, the provider 1102 may then send a selection of one or more particular fulfillment entities 1104 to the fulfillment entities 1104 to cause the fulfillment entities 1104 to ship items from the order.

In various embodiments, the package shipment facilitation system 100 may select the fulfillment entities 1104 according to application of various business rules. In various embodiments, the business rules may be applied as described above. In various embodiments, the business rules may take into account different aspects of the items, fulfillment entities 1104, and/or available shipping options. In various embodiments, the package shipment facilitation system 100 may select a fulfillment entity 1104 based in part on its geographical location, such as, for example, when the fulfillment entity 1104 is nearby to a customer 1108 or is located where a particular shipping option may be available. In other embodiments, the package shipment facilitation system 100 may select a fulfillment entity 1104 based at least in part on the fulfillment entity's speed at fulfilling and shipping an order. In other embodiments, the fulfillment entity 1104 may be selected based at least in part on a cost identified by the fulfillment entity 1104 for fulfilling the order (such as in a bid).

The fulfillment entities 1104 may also send shipment information to the provider 1102, such as which items are being shipped in which containers. In various embodiments, in response to receipt of the information, the package shipment facilitation system 100 of the provider 1102 may modify selected shipping options in order to provide customized shipping based on item identity. Thus, for example, during fulfillment, a fulfillment entity 1104 may indicate to the provider that a particular item has been placed in a box. The provider may, in turn, modify a shipping selection for that box based on the identity of the item. In one example, if the item is of particular value, the provider may indicate that the item should be sent via a more secure, more insured, or faster shipping option.

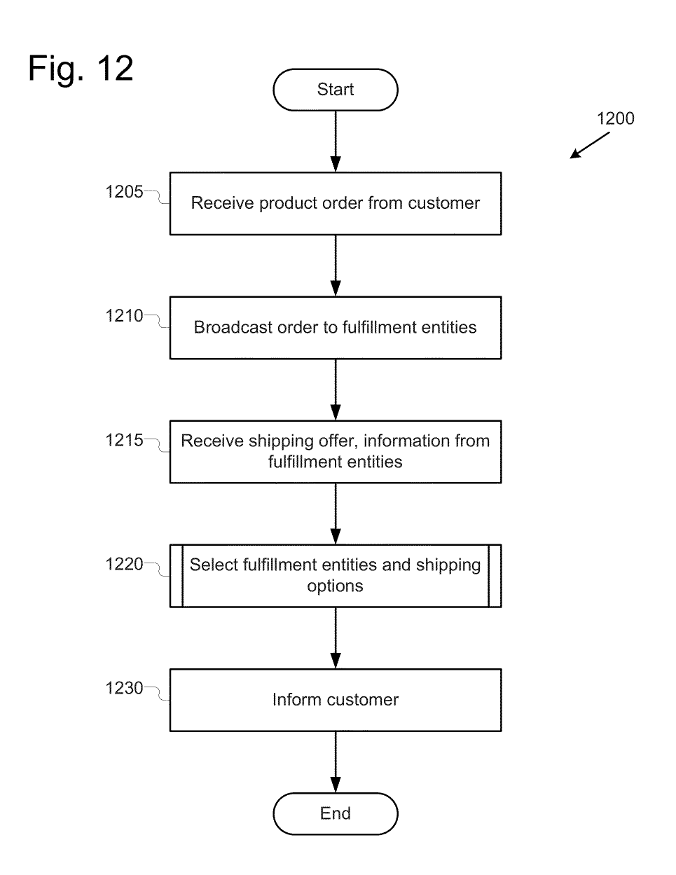

FIG. 12 illustrates a process 1200 for fulfilling orders placed with a provider by one or more fulfillment entities 1104, in accordance with various embodiments. The process may begin at block 1205, where the provider 1102 may receive a customer order for one or more items from a customer 1108. Next, at block 1210, where, the provider 1102, in response to receipt of the product order, may broadcast the order to the fulfillment entities 1104. In various embodiments, the product order may be broadcast by provider 1102 through the fulfillment entity interface 1103. In various embodiments, the fulfillment entity interface 1103 may facilitate broadcast of the order by placing order information in a database or a bulletin board that is accessible or viewable by the stores 1104. In various embodiments, the order information may include information generated by the provider 1104, such as order identifiers and/or order expiration times.

Next, at block 1215, the provider 1102 may receive a shipping offer from the fulfillment entities 1104. As discussed above, in various embodiments, the information may include information to aid the package shipment facilitation system 100 of the provider 1102 to select one of the fulfillment entities 1104. This information may include a bid for fulfilling the order, which may include such information as price information, time-to-fulfillment, time-to-ship and/or other information. The shipping offer may also include non-bid information, such as the geographical location of the fulfillment entity, inventory information, shipping options and/or shippers available to the fulfillment entity, etc.

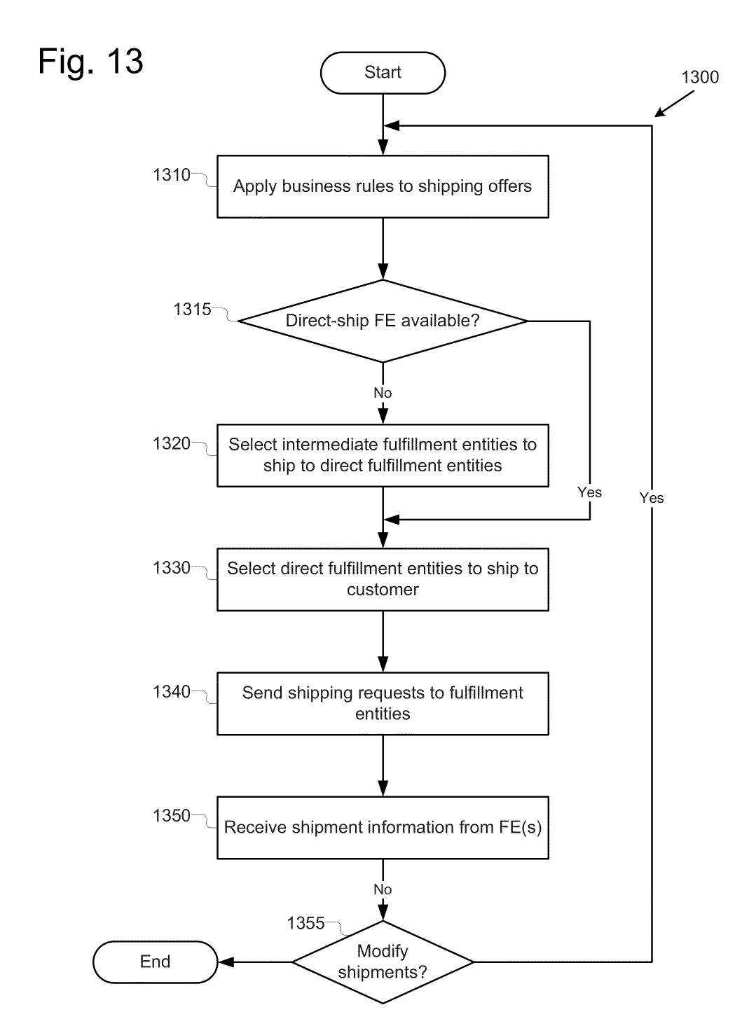

Next, at block 1220, the package shipment facilitation system 100 may select one or more fulfillment entities 1104 and/or shipping options to fulfill and ship the items of the order. Examples of particular implementations of the operation(s) in block 1220 may be described below with reference to FIG. 13. In some embodiments, the process may continue to block 1230, where the customer may be informed of shipment of the one or more items. In various embodiments, the customer may be informed by the provider 1102, the fulfillment entities 1104, or both. The process may then end.

FIG. 13 illustrates a process 1300 for selecting a fulfillment entity 1104 to fulfill an order in accordance with various embodiments. The process may begin at block 1310, where the package shipment facilitation system 100 of the provider 1102 may apply one or more business rules to select that fulfillment entity 1104. In various embodiments, the package shipment facilitation system 100 of the provider 1102 may be configured, such as based on the business rules, to select one or more fulfillment entities 1104 based on a comparative analysis of information and/or bids provided by the fulfillment entities 1104 in their shipping offers. As discussed above, the business rules applied by the package shipment facilitation system 100 of the provider 1102 may select a fulfillment entity 1104 based on information such as cost, time-to-fulfill, time-to-ship, geographical location of the fulfillment entity 1104, available shipping options and/or other information.

In some embodiments, the package shipment facilitation system 100 of the provider 1102 may be configured to allow a fulfillment entity 1104 to “grab” the order by submitting a shipping offer that offers to ship the entire order. In yet other embodiments, the package shipment facilitation system 100 of the provider 1102 may be configured to allow a fulfillment entity 1104 to grab the order by submitting a shipping offer that offers to ship part of the order. In some embodiments, the package shipment facilitation system 100 of the provider 1102 may be configured to allow a fulfillment entity 1104 to grab the order if the fulfillment entity 1104 is the first fulfillment entity 1104 to submit an offer that it can ship all (or part) of the order.

Next, at block 1315, the package shipment facilitation system 100 of the provider 1102 may determine if a direct-ship fulfillment entity 1104 is available to directly ship one or more items from the order to the customer. In various embodiments, the package shipment facilitation system 100 of the provider 1102 may consider only fulfillment entities 1104 out of those identified through application of business rules at block 1310. In various embodiments, the package shipment facilitation system 100 of the provider 1102 may consider only fulfillment entities 1104 out of those that grabbed the order at block 1310.

If there is not a fulfillment entity 1104 available that can directly ship to the customer, then at block 1320, the package shipment facilitation system 100 of the provider 1102 may select one or more intermediate fulfillment entities 1104 to ship one or more items to one or more fulfillment entities that can directly ship to a customer. If there is a fulfillment entity 1104 available that can directly ship to the customer, or if block 1320 has been performed, then at block 1330, the package shipment facilitation system 100 of the provider 1102 may select one or more fulfillment entities 1104 that can directly ship one or more items to the customer. In various embodiments, the fulfillment entities 1104 selected at block 1330 may be the same fulfillment entities 1104 that were selected to be shipped to at block 1320. In various embodiments, in addition to selecting fulfillment entities 1104 at blocks 1320 and 1330, the package shipment facilitation system 100 of the provider 1102 may also select one or more shipping options to be used by the fulfillment entities 1104 when shipping items from the order.

Next, at block 1340, the package shipment facilitation system 100 of the provider 1102 may send shipping requests to the selected fulfillment entities 1104. In various embodiments, the shipping requests may include, for example, one or more of: items that are to be shipped, the identity of the fulfillment entity 1104 that is to ship the one or more items, and or shipping options to be used to ship the one or more items.

At block 1350, the package shipment facilitation system 100 of the provider 1102 may receive shipment information from a fulfillment entity 1104. For example, the fulfillment entity 1104 may send information about one or more items that are being shipped together in a single box. In some embodiments, the package shipment facilitation system 100 may then, at decision block 1355, determine if any shipments should be modified based on the shipment information that has been received. In particular, in some embodiments, the package shipment facilitation system 100 may select different shipping options based on the information received at block 1350.

Thus, if the package shipment facilitation system 100 of the provider 1102 determines that shipments should be modified, in various embodiments the package shipment facilitation system 100 of the provider 1102 may repeat one or more operations starting at block 1310, where the package shipment facilitation system 100 of the provider 1102 applies business rules to the shipping offers, using the new information. In some embodiments, however, during these repeated operations, only shipping options may be modified. However, in order embodiments, selections of fulfillment entities 1104 may be modified as well. If no modifications are made, the process may then end.

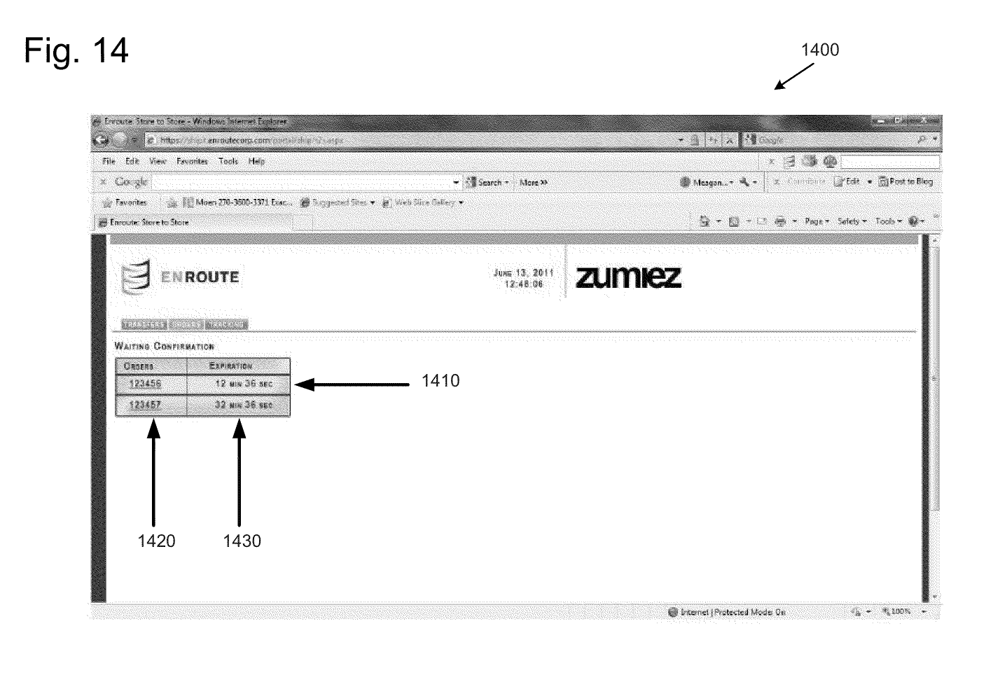

FIGS. 14-17 illustrate, in various embodiments, example interfaces for item fulfillment techniques described herein, in accordance with various embodiments. In various embodiments, the interfaces may be provided by the fulfillment entity interface 1103 of the provider 1102.

FIG. 14 illustrates an example interface 1400 that may be viewed by one or more fulfillment entities to view available orders. As illustrated, the interface 1400 may include a listing of orders 1410. In various embodiments, the list of orders 1410 may include one or more order entries and may display information such as order identifiers 1420 and/or expiration times 1430. In various embodiments, the interface 1400 may allow a fulfillment entity 1104 to select an order, such as by clicking on the order.

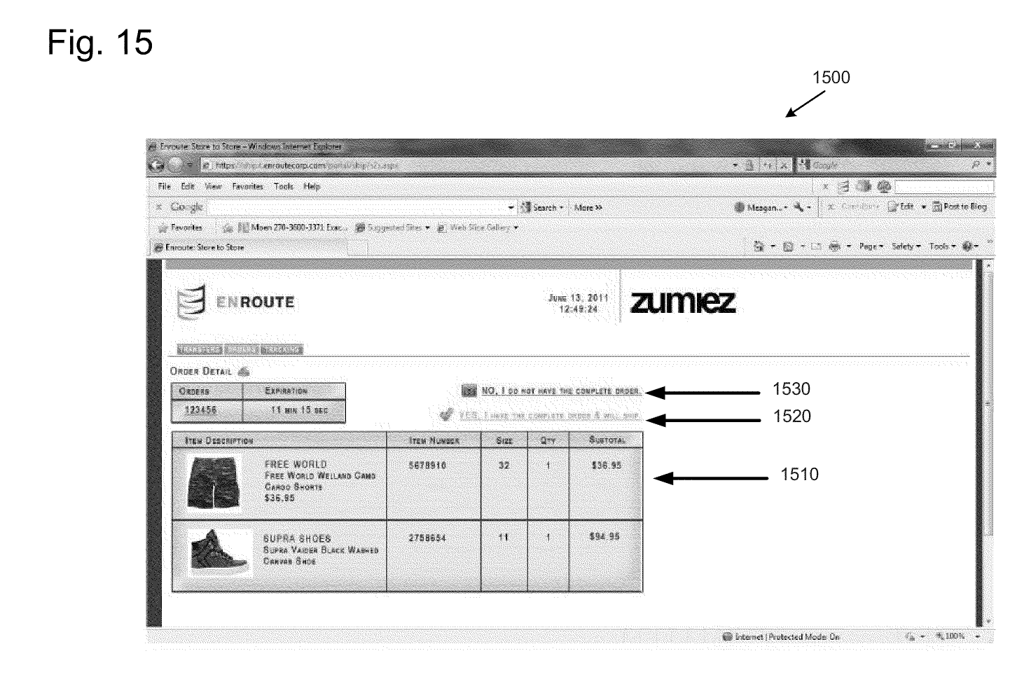

FIG. 15 illustrates an example interface 1500 for displaying order details to a fulfillment entity 1104. In various embodiments, the interface 1500 may include order information 1510, which may, include information such as, but not limited to: customer information, destination address information, product information, etc. In various embodiments, the interface 1500 may also include one or more user interface elements for the fulfillment entity 1104 to make an offer, such as user interface element 1520. In various embodiments, the interface 1500 may also include one or more user interface elements for the fulfillment entity 1104 to decline to make an offer, such as user interface element 1530.

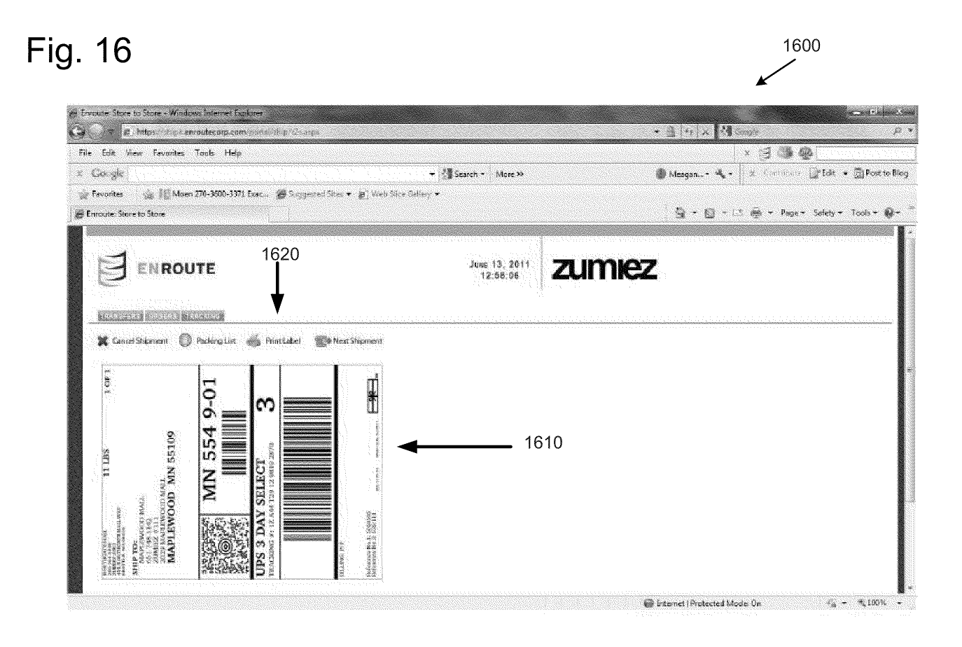

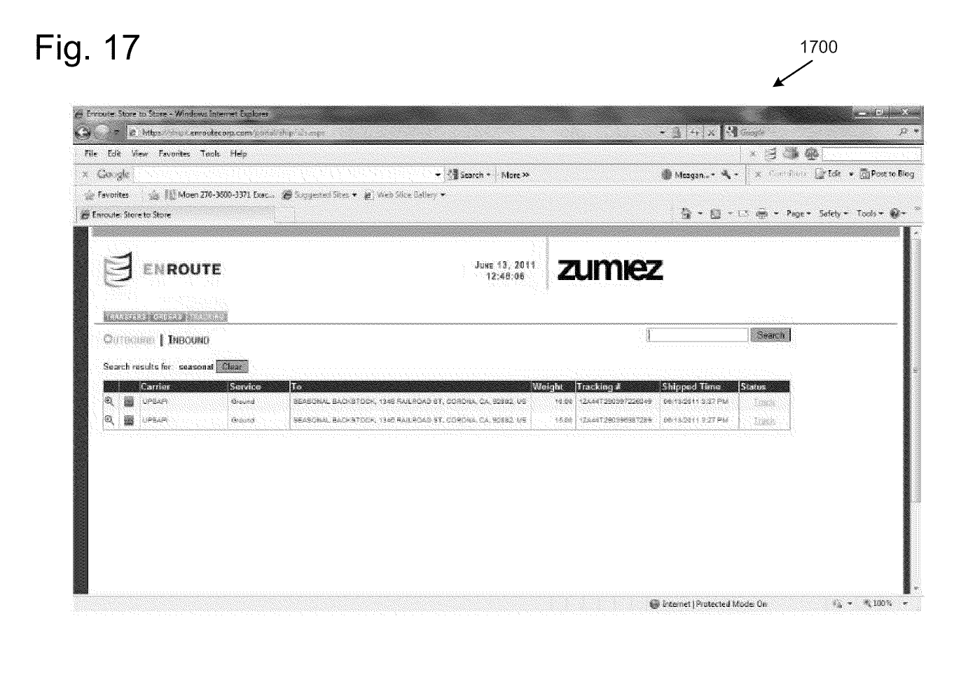

FIG. 16 illustrates an example interface 1600 for providing a shipment label 1610 to a fulfillment entity 1104, such as by the provider 1102. In various embodiments, the interface 1610 may provide a facility to print the shipment label, such as through user interface element 1620. FIG. 17 illustrates an example interface for 1700 for a fulfillment entity 1104 to view tracking information for one or more shipments that have been selected for fulfillment by the fulfillment entity 1104 and which have subsequently been shipped. In various embodiments, these shipments may be shipped to other fulfillment entities 1104 and/or directly to customers.

Although certain embodiments have been illustrated and described herein for purposes of description of the preferred embodiment, it will be appreciated by those of ordinary skill in the art that a wide variety of alternate and/or equivalent embodiments or implementations calculated to achieve the same purposes may be substituted for the embodiments shown and described without departing from the scope of the disclosure. Those with skill in the art will readily appreciate that embodiments of the disclosure may be implemented in a very wide variety of ways. This disclosure is intended to cover any adaptations or variations of the embodiments discussed herein. Therefore, it is manifestly intended that embodiments of the disclosure be limited only by the claims and the equivalents thereof

What is claimed is:

1. A method of facilitating shipment of items, the method comprising:
receiving, by a computing device associated with a provider of the items, an order for one or more items to be shipped;
identifying, by the computing device, one or more fulfillment entities associated with the provider and capable of fulfilling orders from the provider, the identifying being based at least in part on availability of the one or more items at the fulfillment entities; and
selecting, by the computing device, based at least in part on one or more business rules, one or more fulfillment entities to ship the one or more items and one or more shipping options for shipping the one or more items;
wherein the one or more business rules are based at least in part on historical shipping analytic data for the one or more shipping options.

2. The method of claim 1, wherein the one or more fulfillment entities comprise stores of the provider.

3. The method of claim 2, wherein selecting one or more fulfillment entities comprises selecting a store that can directly ship one or more items to a customer.

4. The method of claim 3, wherein selecting one or more fulfillment entities comprises selecting an intermediate store that can ship to the store that can directly ship one or more items to a customer.

5. The method of claim 1, wherein selecting one or more fulfillment entities comprises:
receiving one or more offers from the one or more fulfillment entities to fulfill and ship the one or more items; and
selecting the one or more fulfillment entities based at least in part on the offers and the business rules.

6. The method of claim 1, wherein selecting one or more fulfillment entities comprises:
identifying, based on the one or more fulfillment entities, available shipping options for the available fulfillment entities;
applying the one or more business rules to the available shipping options; and
selecting the one or more fulfillment entities and the one or more shipping options based at least on the application of the one or more business rules to the one or more available shipping options.

7. The method of claim 1, further comprising presenting an order-acceptance user interface and wherein receiving the order comprises receiving an order placed on the order-acceptance user interface.

8. The method of claim 1, wherein selecting one or more shipping options comprises selecting shipping options based on identities of the one or more items.

9. The method of claim 8, wherein selecting shipping options based on identities of the one or more items comprises selecting different shipping options for at least two of the one or more items based on the identities of the one or more items.

10. One or more computer-readable media including instructions written thereon that, in response to execution on a computing device associated with a provider of items, cause the computing device to:
receive an order for one or more items to be shipped;
identify one or more fulfillment entities associated with the provider and capable of fulfilling orders from the provider, based at least in part on availability of the one or more items at the fulfillment entities; and
select, based at least in part on one or more business rules, one or more fulfillment entities to ship the one or more items and one or more shipping options for shipping the one or more items;
wherein the one or more business rules are based at least in part on historical shipping analytic data for the one or more shipping options.

11. The computer-readable media of claim 10, wherein the one or more fulfillment entities comprise stores of the provider.

12. The computer-readable media of claim 10, wherein select one or more fulfillment entities comprises:
receive one or more offers from the one or more fulfillment entities to fulfill and ship the one or more items; and
select the one or more fulfillment entities based at least in part on the offers and the business rules.

13. The computer-readable media of claim 10, wherein select one or more fulfillment entities comprises:
identify, based on the one or more fulfillment entities, available shipping options for the available fulfillment entities;
apply the one or more business rules to the available shipping options; and
select the one or more fulfillment entities and the one or more shipping options based at least on the application of the one or more business rules to the one or more available shipping options.

14. The computer-readable media of claim 10, wherein select one or more shipping options comprises select different shipping options for at least two of the one or more items based on the identities of the one or more items.

15. A system for facilitating shipment of a package, the system comprising:
one or more computer processors;
an analytic history storage coupled to the one or more computer processors, the analytic history storage configured to contain historical analytic data for one or more available shipping options and/or one or more fulfillment entities associated with a provider of items and capable of fulfilling orders from the provider, the historical analytic data comprising empirical data taken from multiple users who have shipped packages;
a business rules storage coupled to the one or more computer processors, wherein the business rules storage is configured to contain one or more business rules based on the historical analytic data in the analytic history storage, and the business rules are configured to identify or more preferred shipping options out of the one or more available shipping options and/or one or more preferred fulfillment entities based on one or more order parameters; and
a business rules application module configured to control the one or more processors, in response to operation by the one or more processors, to apply the one or more business rules to order parameters from a received order of one or more items to be shipped to:
identify one or more fulfillment entities capable of fulfilling orders from the provider based at least in part on availability of the one or more items at the fulfillment entities; and
select one or more fulfillment entities to ship the one or more items and one or more shipping options for shipping the one or more items.

16. The apparatus of claim 15, wherein the one or more fulfillment entities comprise stores of the provider.

17. The apparatus of claim 15, wherein select one or more fulfillment entities comprises:
receive one or more offers from the one or more fulfillment entities to fulfill and ship the one or more items; and
select the one or more fulfillment entities based at least in part on the offers and the business rules.

18. The apparatus of claim 15, wherein select one or more fulfillment entities comprises:
identify, based on the one or more fulfillment entities, available shipping options for the available fulfillment entities;
apply the one or more business rules to the available shipping options; and
select the one or more fulfillment entities and the one or more shipping options based at least on the application of the one or more business rules to the one or more available shipping options.

19. The apparatus of claim 18, wherein select one or more shipping options comprises selecting shipping options based on identities of the one or more items.

20. The apparatus of claim 19, wherein select shipping options based on identities of the one or more items comprises selecting different shipping options for at least two of the one or more items based on the identities of the one or more items.
